(19) United States
(12) Patent Application Publication
(10) Pub. No.: US 2025/0004752 A1
(43) Pub. Date: Jan. 2, 2025

(54) REAL-TIME VERSION ROLLBACK

(71) Applicant: GOOGLE LLC, Mountain View, CA (US)

(72) Inventors: David Shangni Li, Emeryville, CA (US); Dan Chen, Bellevue, WA (US); Ligeng Dong, Bellevue, WA (US); Zachary Warneke, Bellevue, WA (US); Crystal Ying Wang, San Francisco, CA (US); Shumeng Gu, Kirkland, WA (US)

(21) Appl. No.: 18/759,021

(22) Filed: Jun. 28, 2024

Related U.S. Application Data
(60) Provisional application No. 63/510,801, filed on Jun. 28, 2023.

(51) Int. Cl. G06F 8/658; G06F 11/14; G06F 16/14

(52) U.S. Cl. CPC G06F 8/658; G06F 11/1433; G06F 16/152

(57) ABSTRACT

Disclosed implementations for rolling back a web-based application to a prior version. In response to receiving an intent to rollback a web-based application, a prior version of the web-based application that meets a rollback condition is identified. A next version of the web-based application is generated based on the prior version of the web-based application. The next version of the web-based application is published to complete the rollback of the web-based application.

### CROSS REFERENCE TO RELATED APPLICATION

This application claims the benefit of U.S. Provisional Application No. 63/510,801, filed Jun. 28, 2023, the disclosure of which is incorporated herein by reference in its entirety.

### BACKGROUND

Web-based (e.g., browser-based) applications are software programs that are stored on a remote server and use web technologies to deliver one or more functions for the end user over a network through a browser client.

### SUMMARY

Web-based applications (including extensions and other browser-based applications) blend the accessibility of web applications with the user-centric design of mobile apps. Web-based applications include code or data that is downloaded and installed on a user device and are generally designed to function effectively on mobile devices while also having the capability of being delivered through a web browser. These applications are typically offered via an online application repository, referred to as a webstore or app store, and can be modified via updates, which creates a new version of the application. Thus, web-based applications are an example of a managed item with iterative versioning. Current approaches for releasing new or updated versions typically include a multi-day review before publishing. At least one technical problem with this approach is that when an issue or defect is discovered after release, fixing these issues is difficult and time consuming as updated versions and/or rollbacks to address these issues must also be approved via the multi-day review process to ensure the version meets repository guidelines.

The implementations described herein provide at least one technical solution to these technical problems by providing a process to roll back (revert) quickly and securely to a previously released version of a web-based application without requiring review and without changes to the install process used by browser applications. Implementations generate a new version using an existing (e.g., previously released) version of the web-based application and a new version number, in effect making that existing application the new current version. In one example implementation, rollback functionality is enabled by replacing release information (e.g., a version number) and ensuring that deployed contents are otherwise identical to a previously approved and vetted version of the application. Implementations may also verify information (e.g., a signature) related to a current submission of a web-based application and/or the developer of a current submission against a prior submission. Because implementations ensure new versions are generated from previously approved and deployed versions, developers may bypass review and re-deploy quickly.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

Accordingly, in one example, a method includes in response to receiving an intent to rollback a web-based application, identifying a prior version of the web-based application that meets a rollback condition; generating a next version of the web-based application based on the prior version of the web-based application; and publishing the next version of the web-based application to complete the rollback of the web-based application.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1A is a diagram that illustrates an example user interface for receiving a rollback intent, according to some implementations.

FIG. 1B is a diagram that illustrates an example user interface for receiving a rollback intent, according to some implementations.

FIG. 2A is a diagram that illustrates an example user interface for receiving a version number and indication of the rollback, according to some implementations.

FIG. 2B is a diagram that illustrates an example user interface for receiving a version number and indication of the rollback, according to some implementations.

FIG. 3 is a diagram that illustrates a user interface for confirming a rollback intent, according to various implementations.

FIG. 4A is a diagram that illustrates an example architecture that can be employed to execute implementations of the present disclosure;

FIG. 4B is a diagram that illustrates an example environment that can be employed to execute implementations of the present disclosure;

FIG. 5 is a diagram that illustrates a flowchart of a non-limiting processes that can be performed by implementations of the present disclosure; and

FIG. 6 is a diagram that illustrates an example system that includes a computer or computing device that can be programmed or otherwise configured to implement systems or methods of the present disclosure.

### DETAILED DESCRIPTION

The disclosure is related to rolling back changes to managed items with iterative versioning, such as applications, in an expedited manner that preserves security. The described rollback system may be implemented within a platform that provides an online item repository where iterative versions of the item are submitted and reviewed before being released for download and use, including installation. Items are managed items when the items go through a review process conducted by the platform before being made available on the platform for public use. An example of such managed items available on a platform is a software marketplace, which provides an online application repository where iterative versions of an application are submitted for review before being published. Publication releases the item for public use, e.g., for an application publication releases the application for download and installation. The description below describes the rollback system in the context of a platform that provides web-based applications; however, implementations may be used with any platform that provides for submission of items for review before publication (release) and iterative versioning for items. Iterative versioning refers to version numbers that move in one direction, e.g., always increasing or always decreasing. For example, an item with iterative versioning will always have subsequently higher (larger) version numbers assigned to the next version of the item compared to the current version for the item. Decreasing iterative versioning can also be used. Put another way, with iterative versioning, the version number assigned to the next version of an item moves in a single direction. Examples of managed items with iterative versioning can include gaming applications, customized models (e.g., language models), web-based applications such as browser-based applications (e.g., extensions and plug-ins), web sites managed by a platform, and the like, or any other submitted item with iterative versioning, where the item is reviewed before publishing.

In some examples, web-based applications work in conjunction with a browser to provide functionality to a user. Web-based applications include code or data that is downloaded and installed on a user device. Managed items, including web-based applications can be offered via an online item repository, such as an application repository. Application repositories currently offer web-based applications for installation on a user's device. To ensure quality and security, the store may require a web-based application to be hosted at the store and be reviewed before publishing (i.e., before being made available to users). This review ensures that the extension complies with repository guidelines and typically takes multiple days (e.g., 3-4 business days).

A developer of a web-based application may occasionally develop new versions of the application (e.g., to fix bugs or add new functionality). Updates to web-based applications, referred to herein as a new application version or new version, are also subject to review, to ensure the new application version also complies with store guidelines. Until this review is completed, an application repository may not publish the new application version. Publishing the web-based application makes the new application version available for download by browsers. Thus, there can be several business days between when a new version of a web-based application is submitted to the online application repository (webstore) and when it is published by the application repository.

A browser may periodically check a current or executing version against the version offered in the application repository. When the current version is outdated, the browser may be configured to automatically (without user intervention) download and install the newer version of the application. At least one technical problem with this approach is that, in many cases, once the newest version has been installed, a browser cannot roll back to a prior version. Sometimes, however, an application update can introduce an error, which may be undetected until several browsers have installed the updated version. The error can “break” the web-based application and potentially other applications that work with the web-based application, causing users to uninstall the application and/or to distrust the application. Currently, developers who discover issues with their updated web-based application after rolling the application out (i.e., after publishing, after which browsers will start automatic install of the updated version) have no way to quickly fix those issues without going through the multi-day review. Put another way, developers have no way to quickly (e.g., in real time) revert the update as the old version must be (re)submitted to the multi-day review process, and as described above, the browser is unable to rollback to an earlier version number.

As a technical solution to this problem, disclosed implementations provide systems for identifying a previously tested and approved version of a web-based application and immediately (in real time) approving and publishing the version when rollout conditions are met. Implementations minimize the impact of a mistaken or error-prone deployment, unforeseen errors, and broken functionality caused by a web-based application.

Disclosed implementations provide a “rollback” process for reverting an update to a web-based application in real-time and secure and works within the existing browser update process. In some implementations, the rollback process allows developers to skip the review process (e.g., multi-day review). In some implementations, a re-deployed version of a web-based application is not subject to a manual review. As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of embodiments of the present disclosure.

Some implementations provide the rollback process via a developer dashboard. In some implementations, the dashboard is a user interface offered by the application repository and used by application developers to add web-based applications to the store, to update those applications, and roll back (e.g., re-deploy) the web-based applications to a selected (e.g., a last-known usable) version. In some cases, a last-known usable version refers to a prior version of a web-based application that was successfully published with the same visibility settings as the current settings. The dashboard user interface may include a selectable control that is used to indicate an intent to rollback.

In some implementations, the dashboard interface provides functionality for identifying an intent to roll back to a previous version and an interface for effecting the rollback. Implementations enable a developer to provide a new version number for the prior version. The new version number enables browsers to automatically identify the rollback as the current version and install it. Put another way, implementations can automatically re-package a developer's existing extension with a new version number, in effect making that existing extension the new current version. Implementations can include automatic detection of a rollback submission by checking a signature of a current submission against a prior submission.

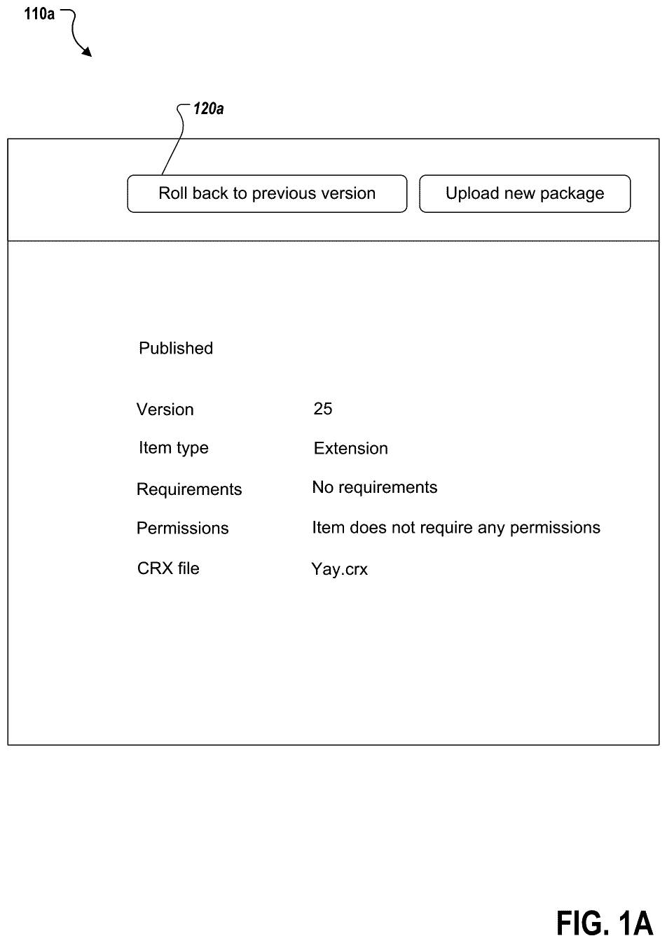

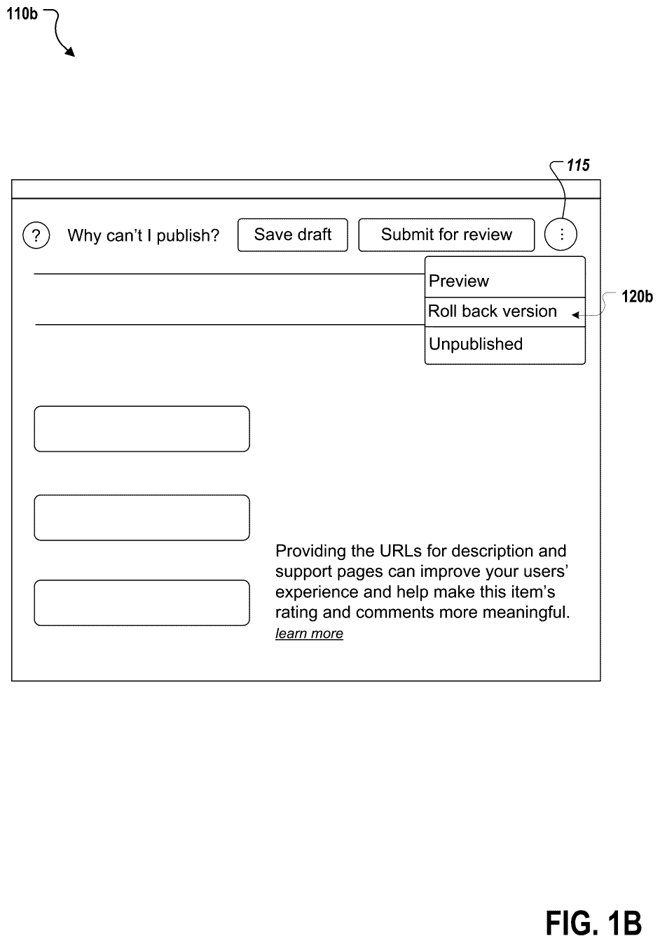

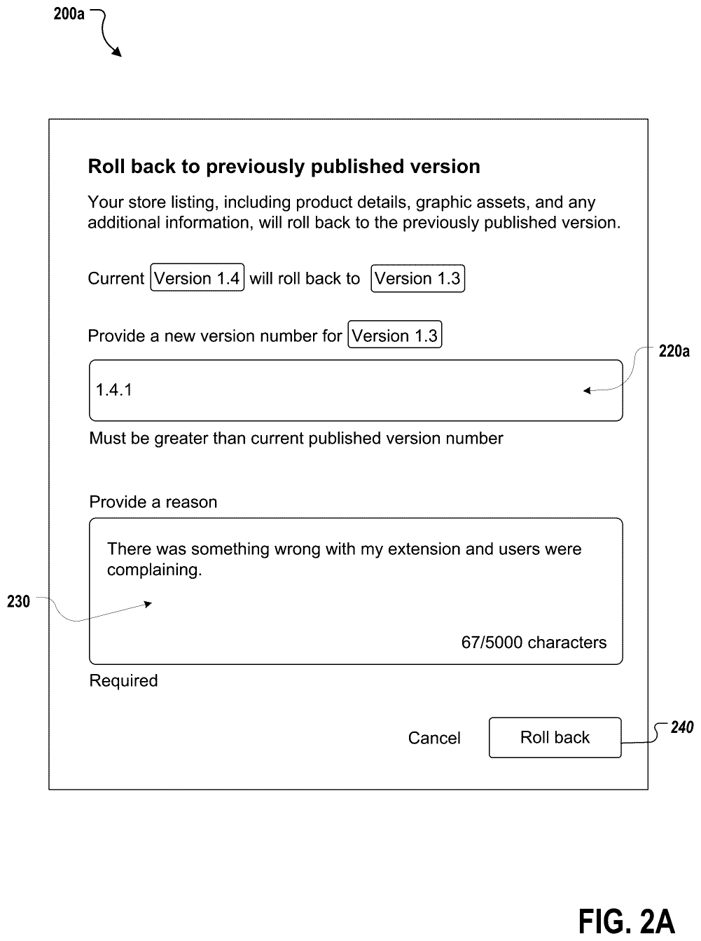

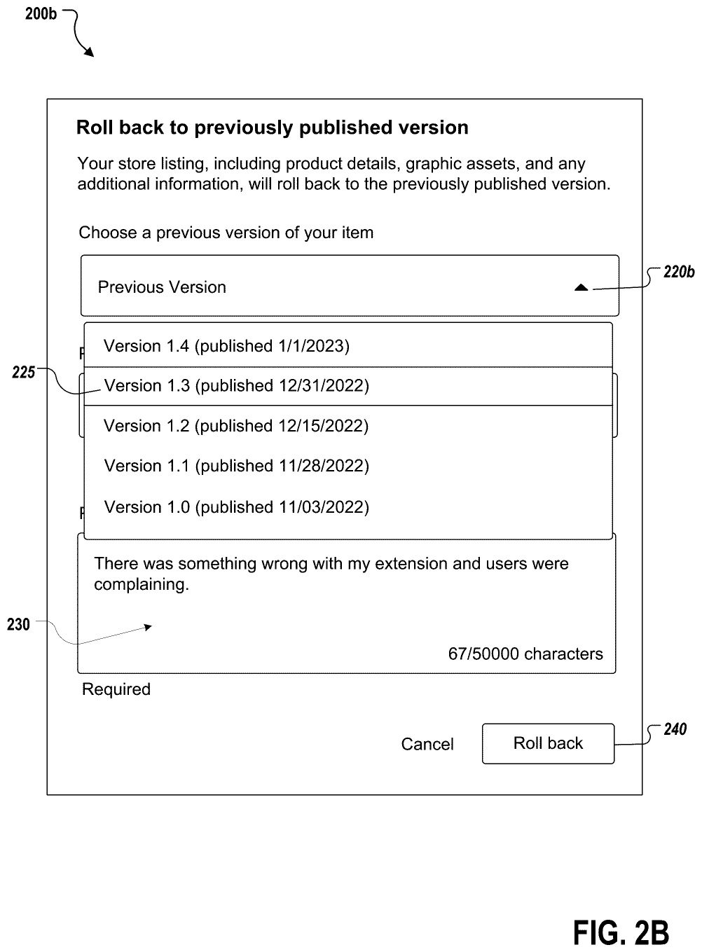

FIG. 1A is a diagram that illustrates an example user interface for receiving a rollback intent, according to some implementations. In the example user interface 110a of FIG. 1A the user interface is a user interface for uploading a new package. Developers may navigate to the user interface 110a after realizing that the current version of the web-based application (e.g., browser-based application) has errors to seek to quickly upload a prior version. In some implementations, if conditions for a rollback are met, the user interface 110a may include rollback intent control 120a. Rollback intent control 120a may be configured to, in response to being selected, surface the rollback user interface (e.g., of FIG. 2A or 2B). In some implementations, if a condition for rollback is not met the user interface 110a may not include rollback intent control 120a.

FIG. 1B is a diagram that illustrates an example user interface for receiving a rollback intent, according to some implementations. In the example user interface 110b of FIG. 1B, the user interface is a user interface for updating a listing in the online application repository. In the example of FIG. 1B, the user interface 110b includes a rollback intent control 120b as part of menu options. In some implementations, if conditions for a rollback are met the user interface 110b may include rollback intent control 120b when the user selects the three-dot menu 115.

Rollback intent control 120b may be configured to, in response to being selected, surface the rollback user interface (e.g., of FIG. 2A or 2B). In some implementations, if a condition for rollback is not met the user interface 110b may not include rollback intent control 120b. Conditions for a rollback may not be met when, for example, a prior version does not exist, when parameters associated with the prior version as set to certain values (e.g., when the visibility is set to “hidden” or when the visibility has been changed from an initial setting), when the current version is a rollback version (i.e., a developer may not be allowed to release rollbacked versions consecutive), when the application has been identified (e.g., marked or flagged) based on releases guidelines, when the current version has not be fully deployed or rolled out, and the like.

FIG. 2A is a diagram that illustrates an example user interface 200a for receiving a version number and indication of the rollback, according to some implementations. User interface 200a is one example of a rollback user interface. In the example of FIG. 2A the user interface 200a includes version identifier control 220a. Version identifier control 220a may be a text box that allows a developer to enter the prior version number of the web-based application to be used in the rollback. In such implementations the system may check the version number entered using version identifier control 220a against one or more rollback conditions. In some implementations, the system may verify that the version number provided by the developer (in the version identifier control 220a) is higher than (i.e., falls after) the current version number of the web-based application.

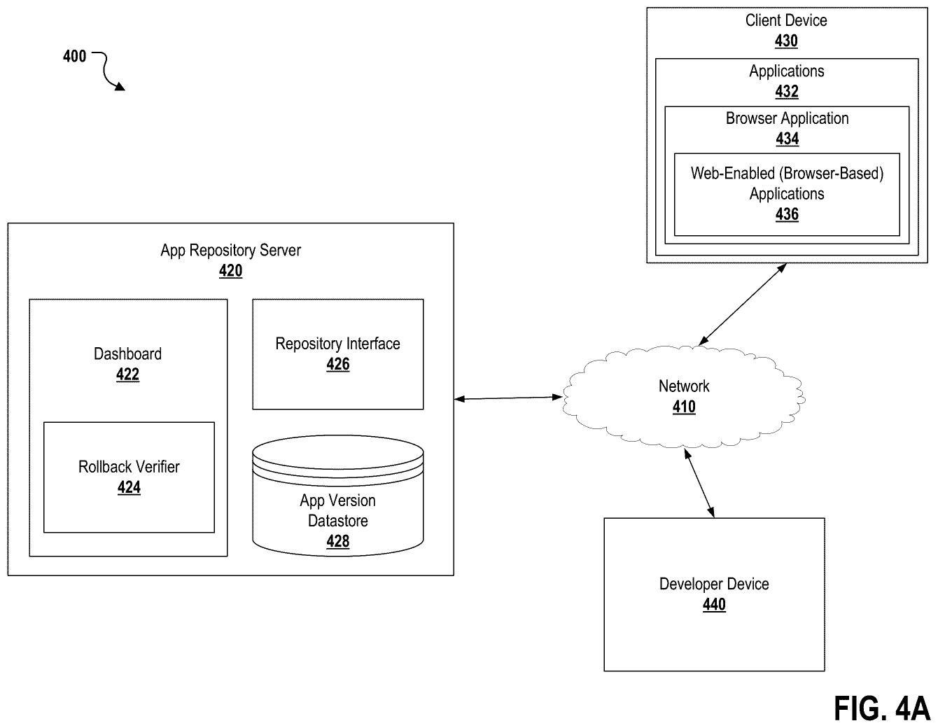

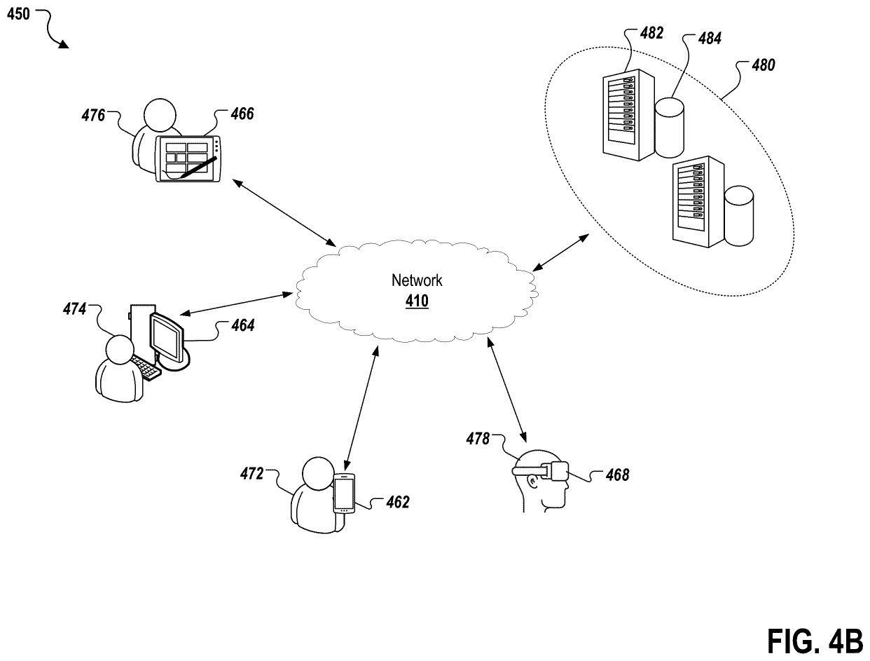

In some implementations, the user interface 200a may include a rollback indication control, such as rollback indication text box 230. The rollback indication text box 230 is a text box used to capture the reason for the rollback. In some implementations, a roll back is dependent on something being entered into the rollback indication text box 230. In other words, the user interface 200a may not allow a developer to execute the roll back until some text is entered in the rollback indication text box 230. In such implementations, the control 240 may not be selectable until text is entered into the rollback indication text box 230. In some implementations, entering text in the rollback indication text box 230 is optional. In some implementations, the content of the rollback indication text box 230 is used to identify the new version number as a rollback version (e.g., in a data store such as in the app version datastore 428 described below with reference to FIG. 4A). In some implementations, the system may add a flag, tag, or other indication that the version number is a rollback version after selection of control 240 (e.g., in the app version datastore 428).

FIG. 2B is a diagram that illustrates an example user interface 200b for receiving a version number and indication of the rollback, according to some implementations. User interface 200b is one example of a rollback user interface. In the example of FIG. 2B, the user interface 200b may provide version identifier control 220b. Version identifier control 220b is a drop-down selection control. The drop-down selection control may be configured to display the current and prior versions of a web-based application. The system can include a datastore of the current and prior versions (e.g., the app version datastore 428). The version identifier control 220b enables the developer to select a version to use as the rollback. In some implementations, only versions that meet a rollback condition (or conditions) are offered as selectable options, e.g., menu option 225, in the version identifier control.

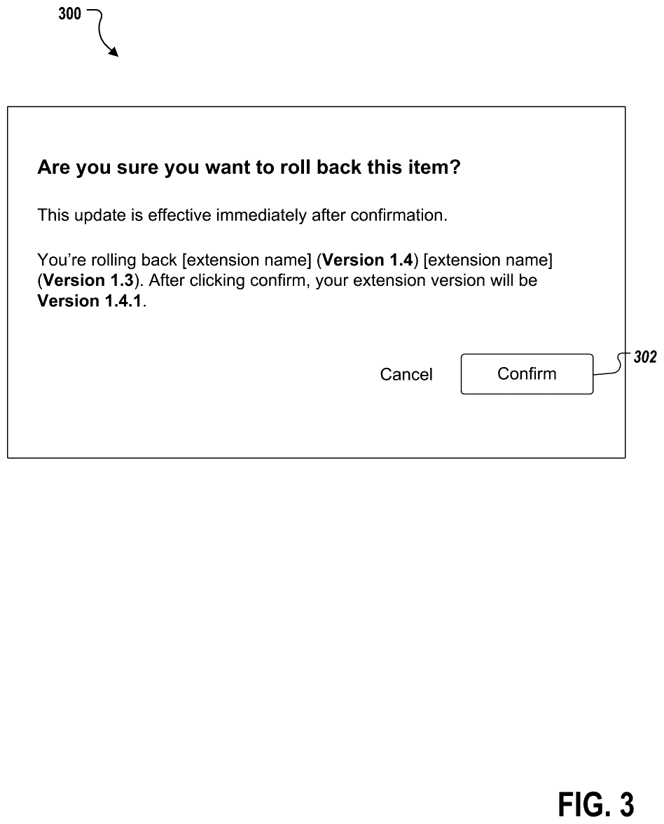

FIG. 3 is a diagram that illustrates a user interface 300 for confirming a rollback intent, according to various implementations. For example, user interface 300 may be presented to the user in response to all rollback conditions being met and the user selecting control 240. In some implementations, a developer provides confirmation to initial the rollback based on a selected prior version by selecting the confirm button 302. In some implementations, the is configured to generate and publish the new rollbacked version (the rollback version) based on confirmation provided with the user interface 300. In some implementations, the system may be configured to bypass the user confirmation and generate and publish a new rollback version without confirmation by the developer.

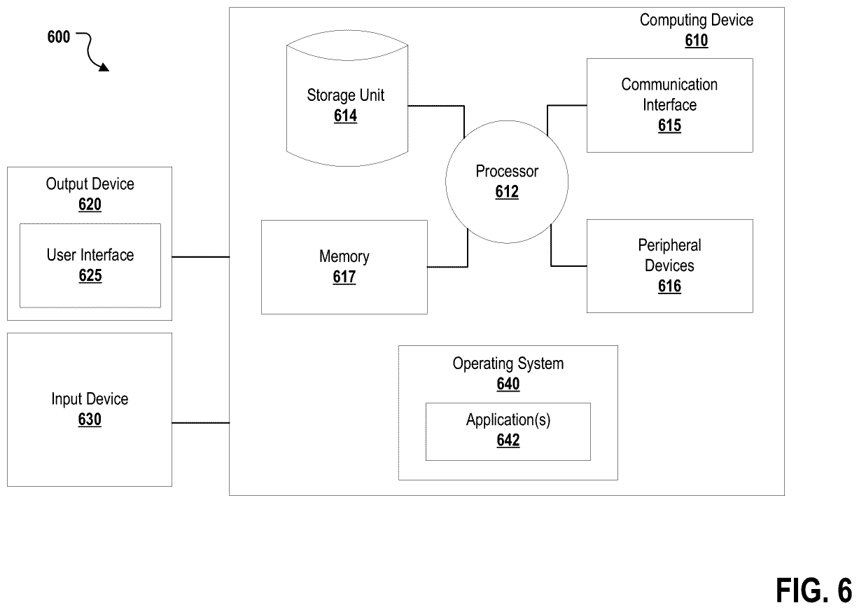

FIG. 4A depicts an example architecture 400 that can be employed to execute implementations of the present disclosure. The example architecture 400 includes a communications network 410, an app repository server 420, a client device 430, and a developer device 440. The communications network 410 is a group of nodes interconnected by links that are used to exchange messages between the nodes. The links may use a variety of technologies based on the methodologies of circuit switching, message switching, or packet switching, to pass messages and signals. The communications network 410 connects (e.g., communicably couples) the app repository server 420, the client device 430, and the developer device 440. The communications network 410 may include a telecommunication or a data network and is described in more detail below with reference to FIG. 4B. In some implementations, the client device 430 and the developer device are sustainably similar to the computing device 610 described below with reference to FIG. 6.

Users of the client device 430 interact with a graphical user interface (GUI) (e.g., the user interface 625 described below with reference to FIG. 6) or an application(s) 432, such as a client application, that is installed and executing on the client device 430. Example client applications include browser 434 (i.e., a browser application). In some implementations, the browser 434 is configured to communicate with other computing devices (e.g., web servers) via the communications network 410 to fetch and render content (e.g., web-based content). In some implementations, the browser 434 provides the content via a display with which a user can interact. For example, the browser 434 may be configured to display webpages, execute web applications, and the like.

In some implementations, the browser 434 receives content by loading a native library, performing a domain name system (DNS) lookup based on a resource locator (e.g., a uniform resource locator (URL)) associated with a particular resource (e.g., a web service provided via a web server) and downloading the provided content. In some implementations, the browser 434 includes a renderer for providing the received content to a user. For example, the browser 434 may be configured to provide content via a browser tab of a browser window that may include a user interface(s) such as user interfaces 110a, 110b, 200a, 200b, and 300 described above with reference to FIGS. 1A,1B, 2A, 2B, and 3, respectively.

Through the use of the browser 434, resources (such as web-based content) may provide a navigation bar, sitemap, dropdown menu, and the like to navigate resources within a domain. In some implementations, the browser 434 includes tools to support navigation, such as bookmarks, browsing history, and the like. In some implementations, the browser 434 defines forward and back buttons to navigate through previously viewed resources (e.g., web pages). In some implementations, the client device 430 is a mobile device and the browser 434 is a mobile browser designed for use on the mobile device. In such implementations, the browser 434 is configured to render and display web-based content in a mobile format (in addition to desktop format).

The browser 434 may include additional functionality in the form of web-based applications such as the browser-based applications 436 (e.g., extensions). In some implementations, the browser 434 is configured to check for version updates to browser-based applications 436. For example, the browser 434 may be configured to communicate with the app repository server 420 (provided via a back-end system, such as the back-end system 480 described below with reference to FIG. 4B) to determine whether a newer version of a browser-based application 436 has been released for download. When a newer version is identified, the browser 434 may download and install the updated version (e.g., via repository interface 426). In some implementations, the browser 434 is configured to periodically check for updates to browser-based applications 436.

As depicted in FIG. 4A, the app repository server 420 includes a dashboard module 422. In some implementations, the dashboard module 422 is an application or service configured to assist a developer (e.g., users of implementations of the developer device 440) with managing browser-based applications 436 stored to the app version datastore 428. In some implementations, once stored to the app version datastore 428, the app repository server 420 is configured to provide the new versions of the browser-based applications 436 to implementations of the browser 434 executed via implementations of the client device 430. In some cases, a developer uses the developer device 440 to communicate, via communications network 410, with the app repository server 420 and provide, via the dashboard module 422, code for download (e.g., new and/or updated versions) and installation as the browser-based application 436. In some cases, the developer device 440 is configured to provide a browser-based application 436 via the dashboard module 422 using known techniques such as a ZIP file, a ZIP file with a special header (e.g., a package), and the like. In some implementations, the dashboard module 422 provides a package interface (e.g., the user interface 110a of FIG. 1A) used for uploading a new package/ZIP file. In some implementations, the dashboard module 422 provides a store interface (e.g., the user interface 110b of FIG. 1B) for managing and/or viewing metadata about a browser-based application, such as browser-based application 436.

In some implementations, the dashboard module 422 includes a rollback verifier module 424. In some implementations, the rollback verifier module 424 allows a developer (e.g., via the developer device 440) to identify a prior version of a browser-based application 436 stored to the app version datastore 428, update the version number of the identified prior version, and immediately publish the new version (e.g., store the updated version in the app version datastore 428 and identify as the latest version of the browser-based application 436) when one or more rollback conditions are met. In some cases, determining that the rollback condition is met includes assessing a status of the prior version of the browser-based application 436. Publishing allows the new version to be available for download and installation by the browser 434 via the repository interface 426. The user interfaces 200a, 200b, and 300 depicted in FIGS. 2A, 2B, and 3 respectively represent user interfaces that may be generated by the dashboard module 422 and/or the rollback verifier module 424.

The app version datastore 428 is implemented via a data store, such as data store 484 described below with reference to FIG. 4B. Examples of items in app version datastore 428 include installable items, such as browser extensions, mobile applications, native applications, and progressive web applications. The app version datastore 428 may be searchable by a limited number of text fields (e.g., via the repository interface 426 provided). For example, the items in the app version datastore 428 may be indexed by terms in an item description, item title, another identifier, terms in a manifest file, and the like. As described above, implementations of the client device 430 may be configured to find and download browser-based applications 436 via the repository interface 426 once uploaded via the developer device 440 via the dashboard module 422.

FIG. 4B depicts an example environment 450 that can be employed to execute implementations of the present disclosure. The example environment 450 includes computing devices 462, 464, 466, 468; a back-end system 480, and the communications network 410. As described above, the communications network 410 is a group of nodes interconnected by links that are used to exchange messages between the nodes. The communications network 410 may include wireless and wired portions. In some cases, the communications network 410 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network.

In some implementations, the communications network 410 includes the Internet, an intranet, an extranet, or an intranet and/or extranet that is in communication with the Internet. The communications network 410 may include a telecommunication or a data network as well as future developed networks. In some implementations, the communications network 410 connects web sites, devices (e.g., the computing devices 462, 464, 466, and 468), and back-end systems (e.g., the back-end system 480). In some implementations, the communications network 410 can be accessed over a wired or a wireless communications link. For example, mobile computing devices (e.g., the smartphone device 462 and the tablet device 466), can use a cellular network to access the communications network 410.

In some implementations, the computing devices 462, 464, 466, and 468 are sustainably similar to the computing device 610 described below with reference to FIG. 6. In some implementations, each of the computing devices 462, 464, 466, and 468 may be employed as one or more of the client device 430 or the developer device 440 described above with reference to FIG. 4A. For example, the same computing device 462, 464, 466, and 468 may be used as both the developer device 440 (e.g., to generate/upload a new version of browser-based application 436) and the client device 430 (e.g., to test whether the browser 434 updates browser-based application 436 to the new version). The computing devices 462, 464, 466, and 468 may include (e.g., may each include) any appropriate type of computing device, such as a desktop computer, a laptop computer, a handheld computer, a tablet computer, a personal digital assistant (PDA), an XR/AR/VR device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

Four user computing devices 462, 464, 466, and 468 are depicted in FIG. 4B for simplicity. In the depicted example environment 450, the computing device 462 is depicted as a smartphone, the computing device 464 is depicted as a tablet-computing device, the computing device 466 is depicted as a desktop computing device, and the computing device 468 is depicted as an XR device. It is contemplated, however, that implementations of the present disclosure can be realized with any of the appropriate computing devices, such as those mentioned previously. Moreover, implementations of the present disclosure can employ any number of devices.

In some implementations, the back-end system 480 includes at least one server device 482 and optionally, at least one data store 484. In some implementations, the server device 482 is sustainably similar to computing device 610 depicted below with reference to FIG. 6. In some implementations, the server device 482 is a server-class hardware type device. In some implementations, the back-end system 480 includes computer systems using clustered computers and components to function as a single pool of seamless resources when accessed through the communications network 410. For example, such implementations may be used in data center, cloud computing, storage area network (SAN), and network attached storage (NAS) applications. In some implementations, the back-end system 480 is deployed using a virtual machine(s).

In some implementations, the back-end system 480 hosts one or more computer-implemented services with which users 472, 474, 476, and 478 can interact using the respective computing devices 462, 464, 466, and 468. For example, in some implementations, the back-end system 480 is configured as the app repository server 420 (described above with reference to FIG. 4A) for implementing the concepts described herein.

In some implementations, the data store 484 is a repository for persistently storing and managing collections of data (e.g., versions of web-based applications such as browser-based application 436). Example data stores that may be employed within the described system include data repositories, such as a database as well as simpler store types, such as files, emails, and so forth. In some implementations, the data store 484 includes a database. In some implementations, a database is a series of bytes or an organized collection of data that is managed by a database management system (DBMS). As described above with reference to the FIG. 4A, implementation of the app version datastore 428 may be provided via the data store 484.

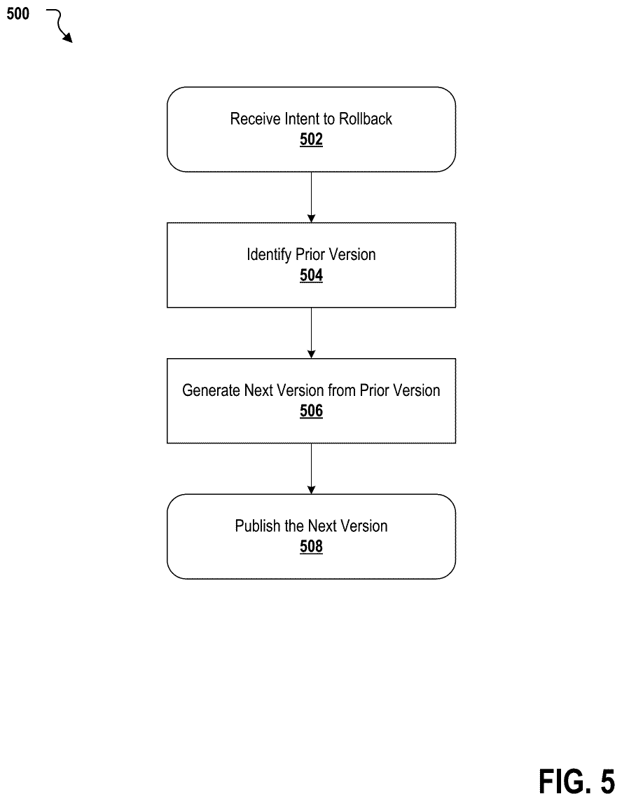

FIG. 5 is a flowchart of an example process 500 that can be implemented by implementations of the present disclosure. The example process 500 can be implemented by systems and components described with reference to FIGS. 1A-4 and 6. The example process 500 generally show in more detail various implementations for rolling back a web-based application to a prior version via an application repository dashboard executing on an application repository server (e.g., provided via the back-end system 480) and making the updated prior version for download and installation on a device (e.g., the client device 430).

For clarity of presentation, the description that follows generally describes the example process 500 in the context of FIGS. 1A-4B and 6. However, it will be understood that the process 500 may be performed, for example, by any other suitable system, environment, software, and hardware, or a combination of systems, environments, software, and hardware as appropriate. In some implementations, various operations of the process 500 can be run in parallel, in combination, in loops, or in any order.

At 502 an intent to rollback a web-based application, such as a browser-based application, is received via a user interface (e.g., the user interfaces 100a or 100b described above with reference to FIGS. 1A and 1B respectively). In some cases, the intent is determined by an express intent. For example, a selection of a rollback intent control, such as rollback intent control 120a or rollback intent control 120b may be received. In some cases, the intent is an implicit intent. The implicit intent may be determined through a comparison of a newly uploaded package. In some cases, whether the newly uploaded package has the same signature as a previously uploaded package is detected.

From 502, the process 500 proceeds to 504 where a prior version of the web-based application is identified. In some implementations, the prior version is identified by retrieving all historical versions of the web-based application (e.g., stored to a datastore such as the app version datastore 428 described below with reference to FIG. 4A). In some implementations, the historical versions are filtered based on a rollback condition (i.e., versions are excluded or included based on meet or not meeting the rollback condition). For example, a version may be excluded when the version is the current published version, the version was never published or not published to a threshold number/percentage of browsers, and so forth.

In some implementations, the rollback condition includes determining that the current version of the web-based application is not a rollback version. In some implementations, the rollback condition includes determining that a parameter associated with the current version has not been changed to a state that disables rollback. For example, a visibility parameter, a parameter indicating whether the web-based application is accessible (e.g., downloadable) is set to a hidden or inactive state. In some implementations, the rollback condition includes determining that the web-based application lacks an identified violation. A violation includes a failure of the web-enabled application and/or a developer associated with the web-enabled application to meet repository guidelines. For example, conditions for a rollback may not be met when a web-based application has been identified (marked/flagged) as subject to a violation (e.g., the web-based application is assigned/associated with a guideline violation when the application fails to meet repository guidelines). In some implementations, the prior version is associated with a first visibility parameter. In some implementations, the rollback condition includes determining that the first visibility parameter matches a second visibility parameter associated with a current version of the web-based application. For example, both the current version and the prior version are set to a visibility that enables downloading of the web-based application.

In some implementations, in response to determining that an intent to roll back the web-based application has been received/has occurred, a rollback user interface is provided. In some cases, the rollback user interface collects a version number of the web-based application to be used as the new version. In some implementations, the filtered list of versions is presented to the user (e.g., via the user interfaces 200a and/or 200b described above with reference to FIGS. 2A and 2B respectively, which are provided via the dashboard module 422 as described above with reference to FIG. 4A) and the user identifies (i.e., selects) a prior version from the filtered list. In some implementations, the prior version is automatically identified by selecting the version from the filtered list having the highest version and/or revision identifier (or based on some other metadata and/or criteria). In some implementations, visibility settings for the identified prior version are verified as the same as the current version and/or that visibility settings were not changed between the two versions.

In some implementations, the rollback conditions are determined and measured against a threshold. In some implementations, where there are multiple rollback conditions that need to be met, one or more of these rollback conditions may be verified (e.g., as a backstop before allowing the automatic publication of the prior version as the updated version). In some implementations, the user is provided (via the dashboard module 422) an indication (e.g., an error message) that the rollback condition(s) is not met when no prior versions of the web-based application meet the rollback condition(s). In some implementations, the indication may be provided to the user via the user interface, such as the user interfaces 200a and 200b described above with reference to FIGS. 2A and 2B respectively, which allows the developer to fix the data (e.g., providing a valid version number and/or indication of the rollback).

From 504, the process 500 proceeds to 506 where a next version of the web-based application is generated based on the prior version of the web-based application. In some implementations, the next version includes a new version number. In some implementations, the new version number may be any number that would cause a browser application (e.g., browser 434) executing on a device (e.g., client device 430) to recognize that an update has occurred for the web-based application (e.g., the web-based application 436) and/or to recognize the need to download and install a newer version of the web-based application.

In some implementations, the next version of the web-based application is generated by extracting code files (e.g., at least one) from a first archive file associated with the prior version of the web-based application. An archive file is a computer file that is composed of one or more files (e.g., code files) along with metadata. An archive file may be used for easier portability and storage and/or to compress files to use less storage space. An archive file may store directory structures, error detection, and correction information, comments. An archive file may be stored in a particular archive format that supports compression of member files. Example archive formats include ZIP, Roshal Archive (RAR), Tape Archive (TAR), 7Z Archive, and the like.

In some implementations, the code files (e.g., a JSON file) extracted from the first archive file are updated with the new version number. In some implementations, a version field is updated but not a version name field of the package to avoid confusing the developer and keeping the version name allows both the developer and users to review to what package the application is being rolled back. For instance, when the application is rolled back from version 1.4 to 1.3 (with version names Ext 1.4″ and Ext 1.3″, respectively), users will see Ext 1.3″ as the version label after the rollback, which accurately reflects what package is installed. In some cases, the version field is updated so that the browser properly receives updates.

Code files generally include instructions that a device (e.g., the client device 430) executes to perform specific tasks or solve problems (e.g., the functionality of the respective web-based application) and/or content associated with the specific tasks or solve problems. Example types of files that may be included in an archive for a web-based application include, but are not limited to, JavaScript Object Notation (JSON) files and Hypertext Markup Language (HTML) files that include content for the web-based application such as scripts (e.g., event scripts, content scripts), image links, sidebars, pop ups, options pages, web-accessible resources, and the like.

In some implementations, the updated at least one code file is compressed to a second archive file. In some implementations, a digital signature is generated based on the second archive file. In some implementations, the digital signature is generated by processing the second archive file and a private key associated with the web-based application through a signing algorithm to generate the digital signature. In some cases, a private key is a cryptographic key that can be used to create a digital signature. A signing algorithm is a cryptographic algorithm used to generate digital signatures, authenticate the sender of a digital message, and prevent message tampering. Example signing algorithms include Digital Signature Algorithm (DSA), Rivest Shamir Adleman (RSA), and so forth. In some cases, the digital signature is verified (e.g., by the browser 434 and/or the repository interface 426) when the versions of the respective web-based application is downloaded.

In some implementations, the next version of the web-based application is generated based on the second archive file and the digital signature. In some implementations, the next version of the web-based application is generated using a dedicated thread pool (i.e., one or more threads dedicated to generating the next version of the web-based application from the prior version).

From 506, the process 500 proceeds to 508 where the next version of the web-based application is published to complete the rollback of the web-based application. In some implementations, publishing the next version of the web-based application further includes providing, to a user interface, version data related to the web-based application. In some implementations, a confirmation of the version data is received from the user interface. In some implementations, the version data includes the new version number, a current version number associated with a current version of the web-based application, and a prior version number associated with the prior version. In some implementations, the next version of the web-based application is published (i.e., made available for download) based on the confirmation.

In some implementations, before publishing the next version of the web-based application, a current version of the web-based application is identified. In some implementations, after publishing the next version of the web-based application, the current version of the web-based application is archived in a repository (e.g., the app version datastore 428) by associating the current version with an archived or inactive state. In some implementations, an indication of the rollback of the web-based application is obtained (e.g., when the new version is published). In some cases, the indication of the rollback is a flag that is not collected from the developer. In some cases, the indication of the rollback is provided by a developer via the dashboard. In some cases, the indication may include a justification or explanation for the rollback. In some implementations, the indication is stored with the new version number and the prior version of the web-based application in a repository (e.g., the app version datastore 428). From 508, the process 500 ends or repeats.

FIG. 6 depicts an example computing system 600 that includes a computer or computing device 610 that can be programmed or otherwise configured to implement systems or methods of the present disclosure. For example, the computing device 610 can be programmed or otherwise configured to implement the process 500 described above with reference to FIG. 5.

In the depicted implementation, the computer or computing device 610 includes an electronic processor (also “processor” and “computer processor” herein) 612, such as a central processing unit (CPU), a tensor processing unit (TPU), or a graphics processing unit (GPU), which is optionally a single core, a multi core processor, or a plurality of processors for parallel processing. The depicted implementation also includes memory 617 (e.g., random-access memory, read-only memory, flash memory), electronic storage unit 614 (e.g., hard disk or flash), communication interface module 615 (e.g., a network adapter or modem) for communicating with one or more other systems, and peripheral devices 616, such as cache, other memory, data storage, microphones, speakers, and the like. In some implementations, the memory 617, electronic storage unit 614, communication interface module 615 and peripheral devices 616 are in communication with the electronic processor 612 through a communication bus (shown as solid lines), such as a motherboard. In some implementations, the bus of the computing device 610 includes multiple buses. In some implementations, the computing device 610 includes more or fewer components than those illustrated in FIG. 6 and performs functions other than those described herein.

In some implementations, the memory 617 and electronic storage unit 614 include one or more physical apparatuses used to store data or programs on a temporary or permanent basis. In some implementations, the memory 617 is volatile memory and can use power to maintain stored information. In some implementations, the electronic storage unit 614 is non-volatile memory and retains stored information when the computer is not powered. In further implementations, memory 617 or electronic storage unit 614 is a combination of devices such as those disclosed herein. In some implementations, memory 617 or electronic storage unit 614 is distributed across multiple machines such as a network-based memory or memory in multiple machines performing the operations of the computing device 610.

In some cases, the electronic storage unit 614 is a data storage unit or data store for storing data. In some instances, the electronic storage unit 614 stores files, such as drivers, libraries, and saved programs. In some implementations, the electronic storage unit 614 stores data received by the device. In some implementations, the computing device 610 includes one or more additional data storage units that are external, such as located on a remote server that is in communication through a network (e.g., the communications network 410 described above with reference to FIGS. 4A and 4B).

In some implementations, platforms, systems, media, and methods as described herein are implemented by way of machine or computer executable code stored on an electronic storage location (e.g., non-transitory computer readable storage media) of the computing device 610, such as, for example, on the memory 617 or the electronic storage unit 614. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 612 is configured to execute the code. In some implementations, the machine executable or machine-readable code is provided in the form of software. In some examples, during use, the code is executed by the electronic processor 612. In some cases, the code is retrieved from the electronic storage unit 614 and stored on the memory 617 for ready access by the electronic processor 612. In some situations, the electronic storage unit 614 is precluded, and machine-executable instructions are stored on the memory 617.

In some cases, the electronic processor 612 is a component of a circuit, such as an integrated circuit. One or more other components of the computing device 610 can be optionally included in the circuit. In some cases, the circuit is an application specific integrated circuit (ASIC) or a field programmable gate arrays (FPGAs). In some cases, the operations of the electronic processor 612 can be distributed across multiple machines (where individual machines can have one or more processors) that can be coupled directly or across a communications network (e.g., communications network 410 described above with reference to FIGS. 4A and 4B).

In some cases, the computing device 610 is optionally operatively coupled to a communications network, such as the communications network 410 described above with reference to FIGS. 4A and 4B, via the communication interface module 615, which may include digital signal processing circuitry. Communication interface module 615 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 610 includes an operating system 640 configured to perform executable instructions. The operating system is, for example, software, including programs and data that manages the hardware (e.g., electronic processor 612, memory 617, electronic storage unit 614, communication interface module 615, peripheral devices 616, and memory 617) and provides services for execution of one or more applications 642. An application is a set of instructions stored in a memory (e.g., memory 617) that are executable by an electronic processor (e.g., electronic processor 612) to perform operations. The above-described hardware components of the computing device 610 can be used to facilitate, for example, the operating system 640 and operations of the one or more applications 642 executed via the operating system 640.

In some cases, the computing device 610 is a personal computing device (or user computing device) such the computing devices 462, 464, 466, and 468 described above with reference to FIG. 4A. In some cases, the personal computing device is configured as the client device 430 and/or the developer device 440 (described above with reference to FIG. 4A) to provide implementation of the described system. In such cases, the applications 642 can include a browser application (e.g., the browser 434). In some implementations, a browser application is integrated into the operating system 640 (e.g., a browser-based operating system).

In some cases, the computing device 610 includes or is in communication with one or more output devices 620. In some cases, the output device 620 includes a display to send visual information to a user. In some cases, the output device 620 is a touch sensitive display that combines a display with a touch sensitive element that is operable to sense touch inputs as and functions as both the output device 620 and the input device 630. In still further cases, the output device 620 is a combination of devices such as those disclosed herein. In some cases, the output device 620 displays a user interface 625 generated by the computing device 610 (e.g., the user interfaces described above with reference to FIGS. 1A, 1B, 2A, 2B, and 3).

In some cases, the computing device 610 includes or is in communication with one or more input devices 630 that are configured to receive information from a user. In some cases, the input device 630 is a keyboard. In some cases, the input device 630 is a keypad (e.g., a telephone-based keypad). In some cases, the input device 630 is a cursor-control device including, by way of non-limiting examples, a mouse, trackball, trackpad, joystick, game controller, or stylus. In some cases, as described above, the input device 630 is a touchscreen or a multi-touchscreen. In other cases, the input device 630 is a microphone to capture voice or other sound input. In other cases, the input device 630 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 612. As such, it should be noted that a plurality of hardware and software-based devices, as well as a plurality of different structural components may be employed to implement various implementations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While some implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

### EXAMPLES

The following paragraphs provide various examples of the implementations disclosed herein.

Example 1 is a method that includes in response to receiving an intent to rollback a web-based application, identifying a prior version of the web-based application that meets a rollback condition; generating a next version of the web-based application based on the prior version of the web-based application; and publishing the next version of the web-based application to complete the rollback of the web-based application.

Example 2 includes the subject matter of Example 1, and further includes generating the next version of the web-based application by: extracting at least one code file from a first archive file associated with the prior version of the web-based application; and updating the at the at least one code file with a new version number.

Example 3 includes the subject matter of Example 1 or 2, and further includes generating the next version of the web-based application further by: compressing the updated at least one code file to a second archive file; generating a digital signature based on the second archive file; and generating the next version of the web-based application based on the second archive file and the digital signature.

Example 4 includes the subject matter of any of Examples 1-3, and further includes generating the digital signature by: processing the second archive file and a private key associated with the web-based application through a signing algorithm to generate the digital signature.

Example 5 includes the subject matter of any of Examples 1-4, and further specifies that the prior version is associated with a first visibility parameter.

Example 6 includes the subject matter of any of Examples 1-5, and further specifies that the rollback condition includes determining that the first visibility parameter matches a second visibility parameter associated with a current version of the web-based application.

Example 7 includes the subject matter of any of Examples 1-6, and further specifies that the rollback condition is a first rollback condition, and that the method further includes determining whether a current version of the web-based application meets a second rollback condition that includes determining that the current version of the web-based application is not a rollback version.

Example 8 includes the subject matter of any of Examples 1-7, and further specifies that the rollback condition is a first rollback condition, and that the method further includes determining whether a current version of the web-based application meets a second rollback condition that includes determining that a visibility parameter associated with the current version has not been changed to a hidden or inactive state.

Example 9 includes the subject matter of any of Examples 1-8, and further specifies that generating the next version of the web-based application includes generating a new version number for the web-based application and that the new version number is a number that causes a client device to recognize that an update has occurred for the web-based application.

Example 10 includes the subject matter of any of Examples 1-9, and further specifies that the rollback condition includes determining that the web-based application lacks an identified violation.

Example 11 includes the subject matter of any of Examples 1-10, and further includes in response to determining that no prior versions of the web-based application meet the rollback condition, providing, to a user interface, an indication that the rollback condition is not met.

Example 12 includes the subject matter of any of Examples 1-11, and further includes publishing the next version of the web-based application further by: providing, to a user interface, version data related to the web-based application; receiving, from the user interface, a confirmation of the version data; and publishing the next version of the web-based application based on the confirmation.

Example 13 includes the subject matter of any of Examples 1-12, and further specifies that the version data includes the new version number, a current version number associated with a current version of the web-based application, and a prior version number associated with the prior version.

Example 14 includes the subject matter of any of Examples 1-13, and further includes before publishing the next version of the web-based application, identifying a current version of the web-based application; and after publishing the next version of the web-based application, archiving the current version of the web-based application in a repository by associating the current version with an archived or inactive state.

Example 15 includes the subject matter of any of Examples 1-14, and further includes obtaining an indication of the rollback of the web-based application; and storing the indication with the new version number and the prior version of the web-based application in a repository.

Example 16 includes the subject matter of any of Examples 1-15, and further specifies the next version of the web-based application is generated using a dedicated thread pool.

Example 17 includes the subject matter of any of Examples 1-16, and further specifies that the web-based application is a customized model.

Example 18 includes the subject matter of any of Examples 1-17, and further specifies that the customized model is a language model.

Example 19 includes the subject matter of any of Examples 1-18, and further specifies that the web-based application is a managed.

Example 20 a computer-readable medium storing instructions that when executed by an electronic processor cause the electronic processor to perform the method as described in any of the Examples 1-19.

Example 21 is a system that includes an electronic processor and a memory communicably coupled to the electronic processor and storing instructions. These instruction, when executed by the electronic processor, cause the system to: receive, from a user interface, an intent to rollback a web-based application; identify a prior version of the web-based application that meets a rollback condition; generate a next version of the web-based application based on the prior version of the web-based application; and publish the next version of the web-based application to complete the rollback of the web-based application.

Example 22 includes the subject matter of Example 21, and further specifies that the instruction, when executed by the electronic processor, further cause the system to generate the next version of the web-based application by: extracting at least one code file from a first archive file associated with the prior version of the web-based application; and updating the at the at least one code file with a new version number.

Example 23 includes the subject matter of Example 21 or 22, and further specifies that the instruction, when executed by the electronic processor, further cause the system to generate the next version of the web-based application further by: compressing the updated at least one code file to a second archive file; generating a digital signature based on the second archive file; and generating the next version of the web-based application based on the second archive file and the digital signature.

Example 24 includes the subject matter of any of Examples 21-23, and further specifies that the instruction, when executed by the electronic processor, further cause the system to generate the digital signature by: processing the second archive file and a private key associated with the web-based application through a signing algorithm to generate the digital signature.

Example 25 includes the subject matter of any of Examples 21-24, and further specifies that the prior version is associated with a first visibility parameter.

Example 26 includes the subject matter of any of Examples 21-25, and further specifies that the rollback condition includes determining that the first visibility parameter matches a second visibility parameter associated with a current version of the web-based application.

Example 27 includes the subject matter of any of Examples 21-26, and further specifies that the rollback condition is a first rollback condition, and that the instruction, when executed by the electronic processor, further cause the system to determine whether a current version of the web-based application meets a second rollback condition that includes determining that the current version of the web-based application is not a rollback version.

Example 28 includes the subject matter of any of Examples 21-27, and further specifies that the rollback condition is a first rollback condition, and that the instruction, when executed by the electronic processor, further cause the system to determine whether a current version of the web-based application meets a second rollback condition that includes determining that a visibility parameter associated with the current version has not been changed to a hidden or inactive state.

Example 29 includes the subject matter of any of Examples 21-28, and further specifies that generating the next version of the web-based application includes generating a new version number for the web-based application and that the new version number is a number that causes a client device to recognize that an update has occurred for the web-based application.

Example 30 includes the subject matter of any of Examples 21-29, and further specifies that the rollback condition includes determining that the web-based application lacks an identified violation.

Example 31 includes the subject matter of any of Examples 21-30, and further specifies that the instruction, when executed by the electronic processor, further cause the system to in response to determining that no prior versions of the web-based application meet the rollback condition, provide, to a user interface, an indication that the rollback condition is not met.

Example 32 includes the subject matter of any of Examples 21-31, and further specifies that the instruction, when executed by the electronic processor, further cause the system to publish the next version of the web-based application further by: providing, to a user interface, version data related to the web-based application; receiving, from the user interface, a confirmation of the version data; and publishing the next version of the web-based application based on the confirmation.

Example 33 includes the subject matter of any of Examples 21-32, and further specifies that the version data includes the new version number, a current version number associated with a current version of the web-based application, and a prior version number associated with the prior version.

Example 34 includes the subject matter of any of Examples 21-33, and further specifies that the instruction, when executed by the electronic processor, further cause the system to before publishing the next version of the web-based application, identify a current version of the web-based application; and after publishing the next version of the web-based application, archive the current version of the web-based application in a repository by associating the current version with an archived or inactive state.

Example 35 includes the subject matter of any of Examples 21-34, and further specifies that the instruction, when executed by the electronic processor, further cause the system to obtain an indication of the rollback of the web-based application; and store the indication with the new version number and the prior version of the web-based application in a repository.

Example 36 includes the subject matter of any of Examples 21-35, and further specifies the next version of the web-based application is generated using a dedicated thread pool.

Example 37 includes the subject matter of any of Examples 21-36, and further specifies that the web-based application is a customized model.

Example 38 includes the subject matter of any of Examples 21-37, and further specifies that the customized model is a language model.

Example 39 includes the subject matter of any of Examples 21-38, and further specifies that the web-based application is a managed.

What is claimed is:

1. A method comprising:
in response to receiving an intent to rollback a web-based application, identifying a prior version of the web-based application that meets a rollback condition;
generating a next version of the web-based application based on the prior version of the web-based application; and
publishing the next version of the web-based application to complete the rollback of the web-based application.

2. The method of claim 1, wherein generating the next version of the web-based application includes:
extracting at least one code file from a first archive file associated with the prior version of the web-based application; and
updating the at the at least one code file with a new version number.

3. The method of claim 2, wherein generating the next version of the web-based application further includes:
compressing the updated at least one code file to a second archive file;
generating a digital signature based on the second archive file; and
generating the next version of the web-based application based on the second archive file and the digital signature.

4. The method of claim 3, wherein generating the digital signature includes:
processing the second archive file and a private key associated with the web-based application through a signing algorithm to generate the digital signature.

5. The method of claim 1, wherein the prior version is associated with a first visibility parameter, and wherein the rollback condition includes determining that the first visibility parameter matches a second visibility parameter associated with a current version of the web-based application.

6. The method of claim 1, wherein the rollback condition is a first rollback condition,
the method further comprising:
determining whether a current version of the web-based application meets a second rollback condition that includes determining that the current version of the web-based application is not a rollback version.

7. The method of claim 1, wherein the rollback condition is a first rollback condition,
the method further comprising:
determining whether a current version of the web-based application meets a second rollback condition that includes determining that a visibility parameter associated with the current version has not been changed to a hidden or inactive state.

8. The method of claim 1, wherein generating the next version of the web-based application includes generating a new version number for the web-based application, and wherein the new version number is a number that causes a client device to recognize that an update has occurred for the web-based application.

9. The method of claim 1, wherein the rollback condition includes determining that the web-based application lacks an identified violation.

10. The method of claim 1, further comprising:
in response to determining that no prior versions of the web-based application meet the rollback condition, providing, to a user interface, an indication that the rollback condition is not met.

11. The method of claim 1, wherein publishing the next version of the web-based application further includes:
providing, to a user interface, version data related to the web-based application;
receiving, from the user interface, a confirmation of the version data; and
publishing the next version of the web-based application based on the confirmation.

12. The method of claim 11, wherein the version data includes a new version number, a current version number associated with a current version of the web-based application, and a prior version number associated with the prior version.

13. The method of claim 1, further comprising:
before publishing the next version of the web-based application, identifying a current version of the web-based application; and
after publishing the next version of the web-based application, archiving the current version of the web-based application in a repository by associating the current version with an archived or inactive state.

14. The method of claim 1, further comprising:
obtaining an indication of the rollback of the web-based application; and
storing the indication with a new version number and the prior version of the web-based application in a repository.

15. The method of claim 1, wherein the next version of the web-based application is generated using a dedicated thread pool, and wherein the web-based application is a customized model.

16. A computer-readable medium storing instructions that when executed by an electronic processor cause the electronic processor to perform operations comprising:
in response to receiving an intent to rollback a web-based application, identifying a prior version of the web-based application that meets a rollback condition;
generating a next version of the web-based application based on the prior version of the web-based application; and
publishing the next version of the web-based application to complete the rollback of the web-based application.

17. A system comprising:
an electronic processor; and
a memory communicably coupled to the electronic processor and storing instructions that, when executed by the electronic processor, cause the system to:
receive, from a user interface, an intent to rollback a web-based application;
identify a prior version of the web-based application that meets a rollback condition;
generate a next version of the web-based application based on the prior version of the web-based application; and
publish the next version of the web-based application to complete the rollback of the web-based application.

18. The system of claim 17, wherein the instructions that, when executed by the electronic processor, cause the system to generate the next version of the web-based application further cause the system to:
extract at least one code file from a first archive file associated with the prior version of the web-based application;
update the at the at least one code file with a new version number;
compress the updated at least one code file to a second archive file;
generate a digital signature based on the second archive file; and
generate the next version of the web-based application based on the second archive file and the digital signature.

19. The system of claim 18, wherein the instructions that, when executed by the electronic processor, cause the system to generate the digital signature further cause the system to:
process the second archive file and a private key associated with the web-based application through a signing algorithm to generate the digital signature.

20. The system of any one of claim 17, wherein the instructions that, when executed by the electronic processor, cause the system to publish the next version of the web-based application further cause the system to:
provide, to the user interface, version data related to the web-based application;
receive, from the user interface, a confirmation of the version data; and
publish the next version of the web-based application based on the confirmation.
